(19) United States
(12) Patent Application Publication
(10) Pub. No.: US 2020/0342619 A1
(43) Pub. Date: Oct. 29, 2020

(54) METHOD AND SYSTEM FOR DATA ENCODING FROM MEDIA FOR MECHANICAL OUTPUT

(71) Applicant: THIKA HOLDINGS LLC, St. Pete Beach, FL (US)

(72) Inventor: Vivien Johan Cambridge, Myrtle Beach, SC (US)

(73) Assignee: THIKA HOLDINGS LLC, St. Pete Beach, FL (US)

(21) Appl. No.: 16/928,647

(22) Filed: Jul. 14, 2020

Related U.S. Application Data
(63) Continuation of application No. 15/873,373, filed on Jan. 17, 2018.
(60) Provisional application No. 62/447,354, filed on Jan. 17, 2017.

(51) Int. Cl. G06T 7/70; G06T 7/11; G06T 7/20; G06T 11/60; G06K 9/46; G06T 11/20; G06K 9/62; G06F 3/0481; G06F 3/01; G06K 9/00; G06T 7/246

(52) U.S. Cl. CPC G06T 7/70; G06T 7/11; G06T 7/20; G06T 11/60; G06K 9/4604; H04M 1/72527; G06K 9/6202; G06F 3/0481; G06F 3/016; G06K 9/00355; G06T 7/248; G06T 11/203

(57) ABSTRACT

A video tracking method is disclosed. The method includes: (a) positioning an input device relative to a first frame of a plurality of video images and selecting an area of the first frame with the input device; (b) analyzing the area to detect parameters associated with movement of the area of the first frame and a surrounding region of the area; (c) tracking the area in subsequent frames of the plurality of frames; (d) re-positioning the input device in at least frame of the subsequent frames and continuously tracking the area in the subsequent frames; (e) extracting movement data associated with the tracking steps (c) and (d); and (f) converting the movement data into a haptics output signal for transmission to a moveable device.

### INCORPORATION BY REFERENCE

The following documents are incorporated by reference as if fully set forth: U.S. Provisional Patent Application 62/447,354 filed Jan. 17, 2017; and U.S. Non-Provisional patent application Ser. No. 15/873,373, filed Jan. 17, 2018.

### FIELD OF THE INVENTION

The present invention is related to a data encoding device.

### BACKGROUND

Existing motion related conversion arrangements convert motion from a video or other type of media associated into a mechanical output device, such that the mechanical output device moves synchronously with events portrayed in the video. For example, in 4D movie theaters, theater seats include motors that move the seats in response to objects moving in the associated film. These known systems include a file containing data which corresponds to movement of objects shown in the associated video. Existing motion detection systems are disclosed in U.S. Pat. Nos. 4,458,266 and 8,378,794, which are incorporated by reference as if fully set forth herein.

Creating files including data to link motion of objects in a video with a mechanical output is time-consuming and labor-intensive process. This process usually includes a manual operator that must watch the video and replicate movement of objects on the screen. The operator's manual input is captured and synchronized with the movie. This process requires prolonged concentrated attention and labor. This process results in an imprecise translation of the movement in the video to the movement to the output device.

Known techniques parameterize the movement of objects depicted in video data. These techniques analyze frames in a video and compare image data to determine if parts of the image are moving to a different location from one frame to another frame. However, the movement analysis techniques of existing systems are not suitable for the analysis of specific motion of specific objects in a video. Current systems for movement analysis analyze movement throughout an image and generate overall data for a scene shown in the video, and cannot generate data for specific objects in the video.

It would be desirable to provide an improved arrangement for encoding and extracting data from motion that is not as labor intensive as known systems and provides precise data encoding and extraction.

### SUMMARY

An improved system and method for extraction of data associated with motion in media is provided. The system and method disclosed herein provides automated or semi-automated extraction of data related to movement in a media file for the purpose of moving mechanical devices in synchrony with events portrayed in the media file. The system disclosed herein allows interactive selection of regions of interest related to objects for further automated detection of movement of said objects through automatic analysis of changing image patterns or morphology around a tracked object. The extracted data may be used to operate or otherwise provide movement of a remote device. The extracted data may also be used to synchronize the motion in the media with the movement of a remote device.

In one embodiment, a video tracking method is disclosed. The method includes: (a) acquiring video images including a plurality of frames; (b) selecting a first frame of the plurality of frames; (c) positioning a cursor on the first frame and selecting an area that is a region of interest of the first frame; (d) analyzing the area to detect parameters associated with movement of the area of the first frame and a surrounding region of the area; and (e) tracking the area in subsequent frames of the plurality of frames. Data associated with movement of the area can be synchronized with the video images. The data associated with movement of the area can be used to control or drive movement of a remote device.

The methods, systems, and algorithms disclosed herein allow a user to extract data from a media file or video related to motion within frames of the media file or video. The user can select a portion of the frame, which can vary in shape and size, and reliably track the portion of the frame in subsequent frames. Data associated with this portion of the frame can then be used to provide an input signal to a device, such as a sex toy device, that imitates or mimics motion captured from the media file or video, or otherwise moves in response to the data corresponding to motion captured from the media file or video.

### BRIEF DESCRIPTION OF THE DRAWINGS

A more detailed understanding may be had from the following description, given by way of example in conjunction with the accompanying drawings wherein:

FIG. 1 illustrates a system according to one embodiment.

FIG. 2 illustrates a flowchart of a method of data encoding according to an embodiment.

FIG. 3 illustrates a flowchart of a method of data encoding according to an embodiment.

FIG. 4 illustrates a flowchart of a method of data encoding according to an embodiment.

FIG. 5A illustrates an embodiment of a system for encoding motion data from a media source.

FIG. 5B illustrates an alternative embodiment of a system for encoding motion data from a media source.

FIGS. 6A and 6B illustrate a method of tracking video according to an embodiment.

### DETAILED DESCRIPTION

According to one embodiment, a portion of an image or screen, which may be referred to as a “specific object” is identified in frames of a media file, such as a video file. The specific object is followed throughout the video data while a movement detection algorithm is implemented to detect and track the specific object and movement thereof. The specific object can also be referred to as a target area or area of interest herein. According to one embodiment, a method for extracting data from a specific object in a media file includes acquiring video image data, interactively tracking objects of interest through an input device controlled by a user, and generating movement data through image processing code based on the data created by the user and by tracking the video images. According to one embodiment, a method for tracking objects by a user identifies the location of a specific moving object and quantifies a rate of motion for the specific moving object.

Throughout the description, the general concept of combining a media file with an output file is described. The embodiments can produce a single data file that includes media, i.e. a video portion, as well as a tracking portion that synchronizes an output signal with the media. The timing of the visual media portions of the file and the output signal can be synched through a variety of known methods, such as described in U.S. Pat. No. 8,378,794.

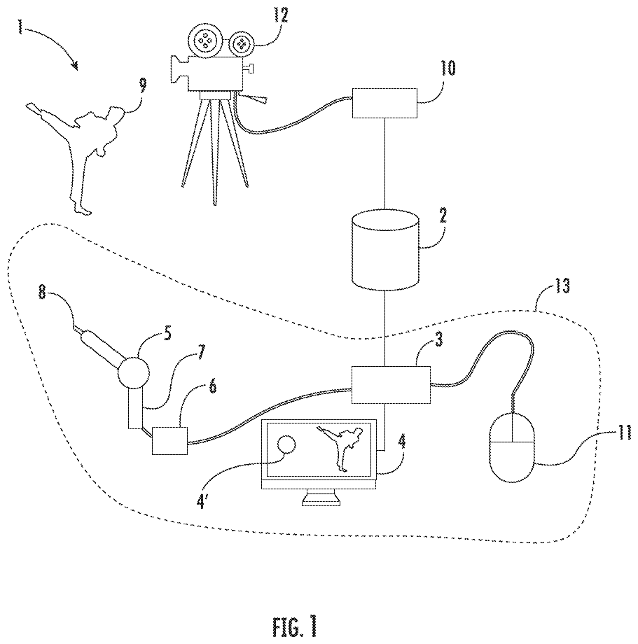

FIG. 1 illustrates one embodiment of a system 1 for extracting data from action motion. As shown in FIG. 1, the system 1 includes a recorder 12 that records a subject 9. As shown in FIG. 1, the recorder 12 is recording a subject 9. One of ordinary skill in the art would recognize that the subject 9 could be any person, place, or object exhibiting motion. Data associated with the recorded image from recorder 12 is provided to encoder 10. As shown in FIG. 1, a wired connection can connect the encoder and the recorder 12. One of ordinary skill in the art would understand that this connection could be wireless.

The encoder 10 can be connected to a network 2. In one embodiment, objects of interest are tracked interactively through an input device 11 and video data related to the subject 9 undergoes a motion detecting algorithm in processor 3. In one embodiment, the input device 11 is a mouse, but one of ordinary skill in the art would recognize that any type of input device can be used. A user can focus on specific objects from the recorded image of the subject 9 by manipulating a position of the input device 11, which is tracked on a display 4. The display 4 overlays a position of a cursor of the input device 11 over the recorded image data of the subject 9. The user can then manipulate specific portions of the recorded image data of the subject 9 to generate motion dependent data for specific portions of the recorded image data of the subject 9. Motion dependent data is transmitted to an output device 13, including an output device processor 6 that causes a motor 5 of an output device 7 to actuate an object 8, wherein movement of the object 8 is related to movement of the subject 9.

In one embodiment, an alternative system 13 can be provided that only includes the processor 3, the display 4, the input device 11, and the output device 7. In this embodiment, the subject 9 is provided completely separated from the system 13. The system 13 can be used in conjunction with any type of video or media file, wherein a user can play the video or media file on the display 4. As the user plays the video or media file, the user can manipulate the input device 11 to focus a cursor 4′ on the display 4 on a specific region of action in the video or media file. The cursor 4′ can include any shape and can include modifiable shape such that a user can decide its shape to focus on a specific region of action of the display 4.

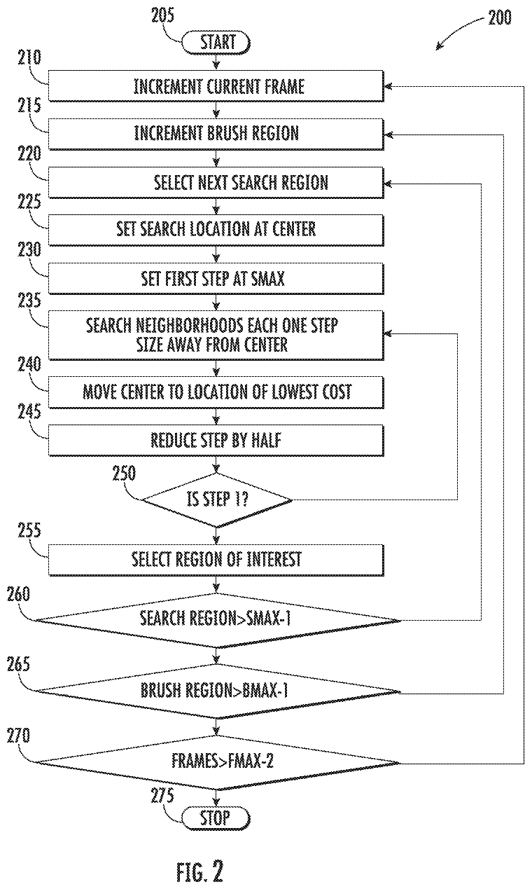

FIG. 2 illustrates a flowchart of a method including steps of a processing algorithm for extracting movements associated with media. The algorithm for method starts at step 205. First, a current frame is incremented. Next, a brush region is incremented. A brush region as used herein can refer to any specific area selected by a cursor-like element. A brush region refers to both a specific cursor area and a surrounding area of influence.

A user can then select a next region as the search region. A first step size is set at Sₘₐₓ. The method includes comparing a neighborhood of areas of interest in sequential images. As used herein, neighborhood includes a surrounding region. In one embodiment, the neighborhood is an area concentrically arranged the search region.

The method 200 includes searching a neighborhood of area of interest. The method can include searching immediately subsequent frames to find locations in the neighborhood that are similar in morphology to that of the location of the area of interest. A center is moved to a location of lowest cost. The algorithm adaptively changes the step size search and extends away from the center of the location of the area of interest.

According to the flowchart of FIG. 2, the process commences by acquiring the current frame and the present brush location. The brush location is a measure of the region of interest containing the tracked object created by the user. The system identifies a first region in the brush location and identifies a first search region and sets a center of search to a center of the first search region. Within the first search region, the system searches eight neighboring pixels around a center of search in the video frame subsequent to the current frame which neighborhoods are centered a certain step size away from center of first search location to find the one neighborhood that is closest to the center of first search region. The system then moves center search location to that location that is closest to the center of first search region, reduces step size by half and repeats the process until reduced step size is one. This process is repeated for all regions contained within the user indicated brush location and that process is repeated for all frames in the video.

As shown in FIG. 2, the algorithm employs a recursive adaptive algorithm for determining movement of objects that occurs in sequential frames of the acquired video imagery. The algorithm commences at step 205 and increments the current frame at step 210 as the algorithm steps through the frames of the acquired media file or video. The system updates the brush region at step 215 to concur with the interactive actions of the user and based on incremented brush region the system determines search region 220 in the current frame. The brush region is understood by those of ordinary skill in the art to be a region corresponding to a region of a cursor or pointer. The brush region has a more complex utility and functionality than a typical cursor on a computer screen or display. The brush region includes an area of influence that has specific dimensions. The brush region can have a varying size, dimensions, density, and other characteristics that are selected by a user. The brush region can have an area of influence with a halo of that decreases in intensity as moving out from a center of the brush region.

Once the search region is established, the method sets the initial location of the search in the center of the search region at step 225, and sets the stab size at the maximum size to be used in the search at step 230. A series of analysis steps are then carried out for the search region. These steps can include any known type of image analysis steps, such as vector analysis, object based image analysis, segmentation, classification, spatial, spectral, and temporal scale analysis. One of ordinary skill in the art would understand alternative types of image analysis can be implemented into this algorithm.

Motion capture analysis and motion detection can be carried out according to a variety of methods and algorithms. In one embodiment, analysis of the frames is carried out by obtaining a reference image from a first frame, and then comparing this reference frame to a subsequent frame. In one embodiment, the algorithm counts the number of pixels that change from one frame or region of a frame to a subsequent frame or region of a subsequent frame. This algorithm continuously analyzes the series of frames to determine if the number of pixels that change exceeds a predetermined value. If the predetermined value is exceeded, then a triggering event occurs. The analysis used in the algorithms disclosed herein also allow for adjustments based on sensitivity and ratio/percentage settings. Other types of motion detection and tracking algorithms can be used in any of the embodiments disclosed herein.

Returning to FIG. 2, the system searches the neighborhood surrounding the center of search by incrementally analyzing neighborhoods surrounding the center of search. In one embodiment, the system searches through eight neighborhoods. One of ordinary skill in the art would understand based on the present disclosure that alternative numbers of neighborhoods can be searched. The neighborhoods are each one step size away from the center of search at step 235. Based on the search of step 235, this system determines the neighboring region where the cost of movement is lowest at step 240. According to this method, cost is defined as the lowest value of some measure of a cumulative pixel difference between the central region and a neighboring region. The system initiates the next iteration in the recursive algorithm by reducing the steps by half at step 245, and the process continues until step size is one at step 250. When the step size has been depreciated to one, the system selects the next region of interest in the current search region in the current frame at step 255, and repeats the process of finding change in the current search region in the current frame at step 260 until the size of the search region is less than the maximum step size one. Upon completion of the computation of change in the current search region of the current frame, the system increments the brush region and repeats the process for search regions in subsequent brush regions of the current frame until all brush regions have been analyzed at step 265. The system loads the next frame in the video sequence at step 270, and repeats the process until all frames have been analyzed at step 275.

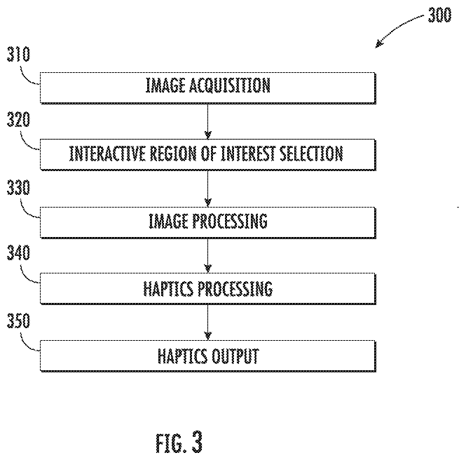

FIG. 3 illustrates one embodiment of a method 300 for providing haptics output based on image acquisition. The method 300 includes image acquisition 310, interactive selection of a region of interest in an image 320, image processing 330, haptics processing 340, and haptics output 350. In one embodiment, the image acquisition 310 step includes pointing a recording device at an image. The image can include any type of media or video. The method 300 allows interactive selection of a region of interest 320 of an image or motion picture. This step 320 can include a user manually moving a recording device relative to an image to select a specific portion of the image for processing. An interactive device can be used to select the region of interest, such as a stylus, mouse, cursor, or other type of movable object. This step can include a user moving a cursor on a screen of a computer to select a region of interest. The specific portion of the image is processed during step 330. This processing step 330 can include an algorithm or other processing step to provide a signal relative to motion in the image. During step 340, haptics processing converts the signals and data from step 330 into haptics signals and data. The term “haptic” is defined as relating to a sense of touch, physical motion, vibration, or tactile sensation. During steps 330 and 340, data related to motion in the image is converted to an output of signals representative of motion from the image. Finally, in step 350, a haptics output is provided. The haptics output can include any type of physical motion experienced by a variety of physical outputs. In one embodiment, the physical output is a sex toy device. One of ordinary skill in the art would recognize that any type of haptics output can be provided.

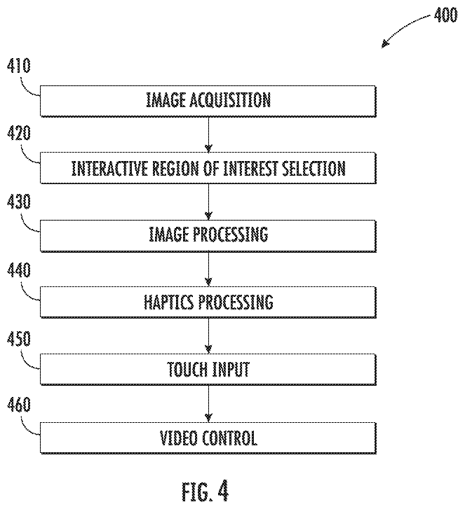

FIG. 4 illustrates another embodiment 400 for converting motion from an image into a haptic output. Steps 410, 420, 430, and 440 are similar to steps 310, 320, 330, and 340, respectively, described with respect to FIG. 3 above. The method 400 includes step 450 which includes a touch input step by a user of the method 400. This step 450 includes inputting data to the system related to a user manipulating an input device. Data related to the touch input is then combined with data from steps 410, 420, 430, and 440. For example, the user may manipulate a joystick to control an object that is displayed on a screen while the object is also controlled by movement data extracted from sequential frames in a video displayed on the screen resulting in an interaction that appears to be controlled by both the user and the moving video. Logic in software in a connected processor may cause video data to change based on this interaction. Video may be slowed or sped up, or new video sources may be accessed in conjunction with the interaction. Therefore, during step 460, video is controlled based on data and input from steps 410, 420, 430, 440, and 450. The video is interactively controlled through the system 400.

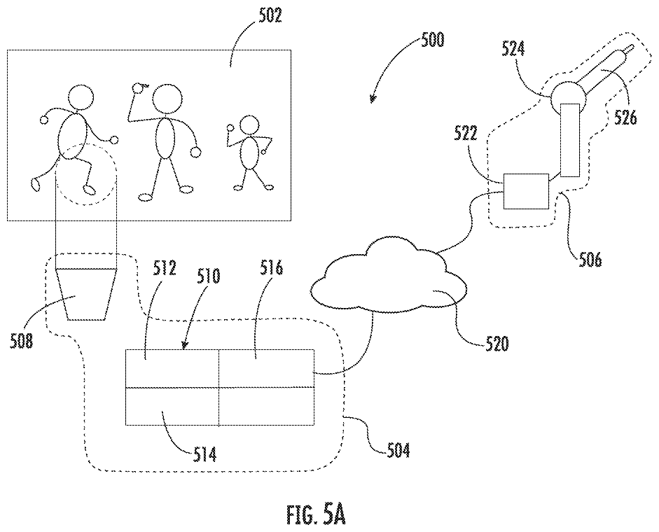

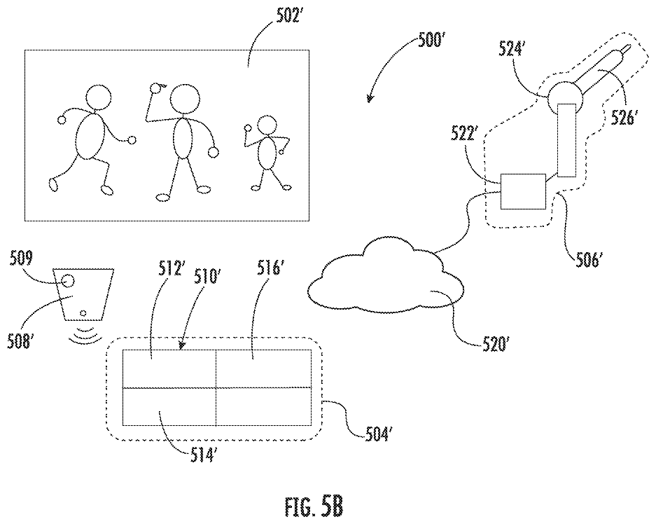

FIG. 5A illustrates an embodiment of a system 500 for encoding data related to motion in media and converting the motion from the media into an output. As shown in FIG. 5, the system 500 generally includes a media source 502, an encoding system 504, and an output arrangement 506. The system 500 allows a user to focus the encoding system 504 on a specific aspect of the media source 502. The encoding system 504 processes moving images from the media source 502, and converts data associated with these images into an output for the output arrangement 506. The media source 502 can include any type of media and any type of motion or moving images. As shown in FIG. 5A, the media source 502 includes three characters. In one embodiment, the media source 502 can include adult-oriented movies or other media depicting sexual acts.

The encoding system 504 includes multiple sub-components. The encoding system 504 includes a recorder 508. The recorder 508 is preferably a hand-held device. The recorder 508 can include an image recording device, such as a camera. The recorder 508 projects a beam or cone onto the media source 502 to record relative motion from the media source 502. In one embodiment, the recorder 508 is connected to a CPU 510. In one embodiment, the CPU 510 includes a processor 512, a memory unit 514, and a transmitter/receiver unit 516. The CPU 510 can include any other known computing or processing component for receiving data from the recorder 508. The encoding system 504 receives a data input of data associated with motion detected by the recorder 508, and outputs a signal representative of the data associated with the motion detected by the recorder 508. A user can adjust the recorder 508 relative to the media source 502 in a variety of ways. For example, the user can manually move the recorder 508 to focus on different regions of the media source 502. The user can adjust a size of the beam or cone of the recorder 508 to record a larger or smaller region of the media source 502. The user can also adjust a shape of the beam or cone of the recorder 508 projected onto the media source 502.

As shown in FIG. 5A, the encoding system 504 is connected to a wireless network 520. In one embodiment, the wireless network 520 is an internet connection. One of ordinary skill in the art would understand that any known type of connection can be provided.

The output arrangement 506 includes a transmitter/receiver unit 522. The transmitter/receiver unit 522 receives a signal from the encoding system 504 via the wireless network 520. The output arrangement 506 includes a motor 524. The motor 524 is configured to provide a driving motion based on signals received from the encoding system 504. The motor 524 drives an output device 526. In one embodiment, the output device 526 is a phallic sex toy device. One of ordinary skill in the art would recognize from the present disclosure that alternative outputs can be provided with varying shapes, sizes, dimensions, profiles, etc.

Another embodiment is illustrated in FIG. 5B. The elements of this embodiment are similar to the elements as described in FIG. 5A unless otherwise described in further detail with respect to FIG. 5B, and are indicated with a prime annotation. In this embodiment, the recorder 508′ does not project a beam or cone on to the media source 502′ as disclosed in the embodiment of FIG. 5A. Instead, the recorder 508′ is an electronic device including a motion sensor 509. In one embodiment, the recorder 508′ is a cell phone, such as a smart phone or other electronic device. Existing cell phones and smart phones include a variety of motion sensors, accelerometers, and other detectors that allow a user to track a variety of characteristics of movement. The recorder 508′ allows a user to mimic a specific motion displayed on the media source 502′ such that a user can create a file containing data related to motion displayed by the media source 502′. A user can manipulate the recorder 508′ in a variety of ways, and in any direction. The user then provides a data file related to data recorded by the recorder 508′ to the encoding system 504′. The encoding system 504′ can then synchronize the data file from the recorder 508′ with the source file for the media or video being displayed on the media source 502′. As shown in FIG. 5B, the encoder 508′ provides a wireless connection to the encoding system 504′. One of ordinary skill in the art would understand that any type of connection can be provided from the encoder 508′ to provide a method for uploading the data file including the motion data. This embodiment allows a user to use their existing cell phone or smart phone and convert their phone into a data encoding device for tracking motion in a media or video file.

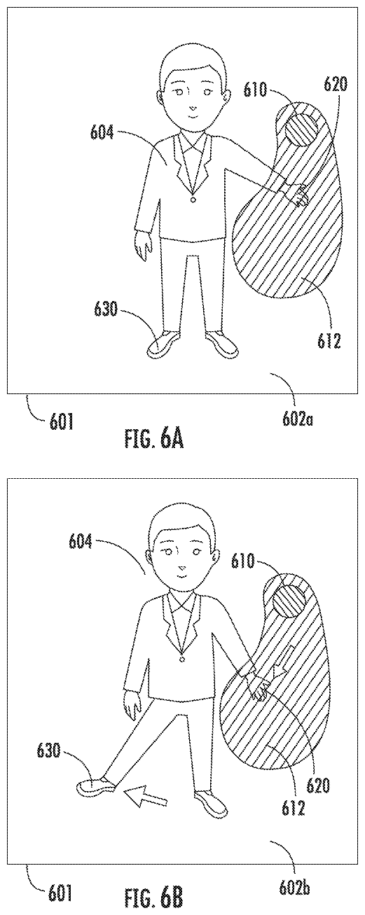

FIGS. 6A and 6B illustrate another embodiment in which a series of frames 602a, 602b of a media file or video are analyzed according to the methods and systems described herein. As shown in FIG. 6A, an object 604 is shown on the display 601. The display 601 can include any of the features and connections described herein with respect to the other embodiments. The display 601 is connected to a processor according to any of the embodiments described herein. An algorithm according to the embodiments described above is used to analyze the frames 602a, 602b. As shown in FIG. 6A, the object 604 (representing a person) has a hand 620 in a slightly raised position. As shown in FIGS. 6A and 6B, the system tracks a hand 620 of the object, and does not track a foot 630 of the object.

The user manipulates a position of the cursor 610 to create a region of interest 612 to focus on any portion of the frame 602a. The region of interest 612 contains the object to be tracked, i.e. the hand 620, and does not include objects that are not to be tracked, i.e. the foot 630. The term cursor is used generically to refer to element 610. One of ordinary skill in the art would understand the cursor 610 can include a brush or pointer and can have any type of shape or dimension. The cursor 610 can be moved interactively by a user to select a specific region of interest to the user for data encoding. In one embodiment, the cursor 610 is a plain pointer. In another embodiment, the cursor 610 is a brush shaped icon or cloud, and analogous to the brush region described above. In another embodiment, the cursor 610 is a spray paint icon.

The user can move a mouse or other object to manipulate a position of the cursor 610 relative to the frame 602a. Once in a desired position on the frame, the user can then select a specific region of the frame 602a and the cursor 610 marks the specific region of the frame 602a. This marking can occur by a variety of methods, such as discoloring the specific region or otherwise differentiating the specific region from adjacent pixels and surrounding colors. This selecting/marking step does not affect the subject video file or frames 602a, 602b and instead is an overlay image, pattern, marking, or indicator that is used by the algorithm for tracking purposes. The cursor 610 in FIG. 6A creates a marking 610 in FIG. 6B that tracks with any movement of the specific region of the object 604. Tracking of the specific region is achieved by the methods and algorithms described above. Although the object's foot 630 also moves from FIG. 6A to FIG. 6B, the tracking system only tracks the specific region of the hand 620 since this area was selected by the cursor 610.

The tracking algorithm automatically detects the object's hand 620 moved from a raised position in FIG. 6A to a lowered position in FIG. 6B. For example, a processor can analyze the selected region 610, 610′ and determine the parameters of this selected region. As the frames advance from frame 602a to frame 602b, the algorithm analyzes a lowest value of some measurement of cumulative pixel differentiation between the selected region and neighboring regions. For example, if the background of the frame 602a is white and the tracked arm of the object 604 is green, then the algorithm is used to detect where the green tracked arm of the object 604 moves to in the frame 602b. Other types of differential analysis and processes can be applied to the frames 602a, 602b to determine where the specific region is moving between the frames 602a, 602b. The cursor 610 is effectively locked on to a specific region of the frame 602a by a user and the specific region is then automatically tracked by the algorithm in frame 602b and subsequent frames. Data regarding the tracked movement of the specific region selected by the cursor 610 can then be converted to a output signal. The output signal can then be used to operate a sex toy device or any other type of physical device. In one embodiment, the output signal is synched with the media file or video in a combined data file. Other users can then download the combined data file which includes both video and an output signal. The combined data file can then be used by other users to control a sex toy device, such that the sex toy device imitates motion from the media file or video. For example, the sex toy device moves in a similar manner, direction, speed, and other physical characteristics as the selected region from the frames. The analysis of the frames 602a, 602b is limited to the area selected by the cursor 610, and all other motion in the frames 602a, 602b is not analyzed. This arrangement provides an isolated algorithm and method for analyzing a video or media file, such that the output is limited to the specific region selected by the user.

The embodiments disclosed herein allow a user to extract motion or movement data from any video or media file. The embodiments disclosed herein can be embodied as software or other computer program, wherein a user downloads or installs the program. The program can be run any known computing device. The video or media file can be played within a window on the user's computer. The program can include a toolbox or other menu function to allow the user to adjust the cursor or brush region, control playback of the media file or video, and other commands. The user can manipulate an input device, such as a mouse, to move the cursor or brush region relative to a selected frame. The user can activate the input device to select a specific region of the frame. The cursor can allow the user to draw a closed shape around a specific region to focus on for analysis.

It will be appreciated that the foregoing is presented by way of illustration only and not by way of any limitation. It is contemplated that various alternatives and modifications may be made to the described embodiments without departing from the spirit and scope of the invention. Having thus described the present invention in detail, it is to be appreciated and will be apparent to those skilled in the art that many physical changes, only a few of which are exemplified in the detailed description of the invention, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiment and optional configurations are therefore to be considered in all respects as exemplary and/or illustrative and not restrictive, the scope of the invention being indicated by the appended claims rather than by the foregoing description, and all alternate embodiments and changes to this embodiment which come within the meaning and range of equivalency of said claims are therefore to be embraced therein.

What is claimed is:

1. A video tracking method, the method comprising:
(a) positioning an input device relative to a first frame of a plurality of video images and selecting an area of the first frame with the input device;
(b) analyzing the area to detect parameters associated with movement of the area of the first frame and a surrounding region of the area;
(c) tracking the area in subsequent frames of the plurality of frames;
(d) re-positioning the input device in at least frame of the subsequent frames and continuously tracking the area in the subsequent frames;
(e) extracting movement data associated with the tracking steps (c) and (d); and
(f) converting the movement data into a haptics output signal for transmission to a moveable device.

2. The method of claim 1, wherein the input device is a hand-held component.

3. The method of claim 1, wherein the input device is an image recording device configured to project a beam or cone onto the plurality of video images.

4. The method of claim 3, wherein a size of the beam or cone can be adjusted.

5. The method of claim 1, wherein a user manually positions the input device relative to a monitor displaying the plurality of video images.

6. The method of claim 1, wherein the moveable device is a sex toy device, and wherein the sex toy device moves in response to the haptics output signal.

7. The method of claim 1, further comprising:
(g) synching the movement data with the video images, and creating a combined data file including the movement data synched with the video images.

8. The method of claim 7, wherein the combined data file is configured to provide input to a sex toy device, wherein the sex toy device is configured to move based on the movement data.

9. The method of claim 1, wherein the input device defines a brush region on the plurality of video images.

10. A video tracking system, the system comprising:
a monitor displaying a video file;
an input device configured to be moved by a user, wherein the input device creates a motion file; and
a CPU configured to synchronize the video file with the motion file to create a combined data file.

11. The system of claim 10, wherein the input device is a hand-held device external from the CPU.

12. The system of claim 10, wherein the input device is an image recording device configured to project a beam or cone onto the plurality of video images.

13. The system of claim 10, wherein the input device is configured to be continuously moved by the user.
